(19) United States
(12) Patent Application Publication
(10) Pub. No.: US 2016/0127441 A1
(43) Pub. Date: May 5, 2016

(54) APPLICATION LEVEL AUDIO CONNECTION AND STREAMING

(71) Applicant: Microsoft Corporation, Redmond, WA (US)

(72) Inventors: Oleksandr Monastyrskyy, Bellevue, WA (US); Luke Norman Angelini, Seattle, WA (US); Vincent Bellet, Kirkland, WA (US); Steven Wilssens, Bothell, WA (US); Michael David McCormack, Seattle, WA (US); Chi Owunwanne, Renton, WA (US); Todd R. Manion, Seattle, WA (US); Scott Allen Plette, Kirkland, WA (US); Anders Edgar Klemets, Redmond, WA (US); Relja Ivanovic, Seattle, WA (US)

(73) Assignee: MICROSOFT CORPORATION, Redmond, WA (US)

(21) Appl. No.: 14/529,003

(22) Filed: Oct. 30, 2014

(51) Int. Cl. H04L 29/06

(52) U.S. Cl. CPC H04L 65/602; H04L 65/4076

(57) ABSTRACT

Systems and methods disclosed herein may include receiving from an audio application running on the computing device, a selection of a multimedia endpoint device. The multimedia endpoint device may be connected with the audio application in response to a request from the audio application. An audio stream of the audio application may be separated from a system audio stream. The system audio stream may include a plurality of audio signals generated by system components of the computing device or applications running on the computing device. The plurality of audio signals may be played on a default audio endpoint of the computing device. The separated audio stream of the audio application may be communicated to the selected multimedia endpoint device for playback. Separating the audio stream of the audio application from the system audio stream may be based on an API request from the application.

### BACKGROUND

As computing technology has advanced, increasingly powerful mobile devices have become available. For example, smart phones and other computing devices have become commonplace. The processing capabilities of such devices has resulted in different types of functionalities being developed, such as multimedia-related functionalities, including streaming of audio and video data to various multimedia endpoints. However, a multimedia endpoint (e.g., a Bluetooth audio and/or video-enabled endpoint device) connected to the host computing device at the system level results in various system sounds generated by the device, as well as any additional multimedia stream, to be communicated to the same multimedia endpoint. In this regard, if the multimedia endpoint is used to playback an audio stream, various system sounds (e.g., notification alarms) will also be played back on the multimedia endpoint at the same time the audio stream is being played back.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a method for processing audio information is disclosed and may include receiving from an audio application running on the computing device, a selection of a multimedia endpoint device. The multimedia endpoint device may be connected with the computing device in response to a request from the audio application. An audio stream of the audio application may be separated from a system audio stream. The system audio stream may include a plurality of audio signals generated by system components of the computing device or applications running on the computing device. The plurality of audio signals are played on a default audio endpoint of the computing device. The separated audio stream of the audio application may be communicated to the selected multimedia endpoint device for playback.

In accordance with one or more aspects, a computing device that includes a processor and memory, may be adapted to perform a method for processing audio information. The method may include receiving a selection of a default playback device for an audio application running on the computing device, where the selection is performed using the audio application. A request may be received from the audio application, where the request is for rendering audio stream of the audio application on the default playback device. The default playback device plays back a plurality of audio signals generated by system components of the computing device or applications running on the computing device. In response to a stream separation request, the audio stream of the audio application may be separated from a system audio stream comprising the plurality of audio signals. The stream separation request may be received as part of the rendering request. The separated system audio stream may be re-routed from the default playback device to at least another playback device. The separated audio stream of the audio application may be routed to the default playback device for playback.

In accordance with one or more aspects, a computer-readable storage medium may include instructions that upon execution cause a computer system to receiving from a first audio application running on the computing device, a selection of a Bluetooth playback device. The Bluetooth playback device may be connected with the computing device in response to a request from the first audio application. An audio stream of the first audio application may be separated from a system audio stream. The system audio stream may include a plurality of audio signals generated by system components of the computing device or applications running on the computing device. The plurality of audio signals may be played on a default audio endpoint of the computing device. The separated audio stream of the first audio application may be communicated to the selected Bluetooth playback device for playback. While playing back the separated audio stream of the first audio application, a request may be received from a second audio application running on the computing device, the request for rendering audio stream of the second audio application on the Bluetooth playback device. The separated audio stream of the first audio application may be re-routed from the Bluetooth playback device to the default audio endpoint.

As described herein, a variety of other features and advantages can be incorporated into the technologies as desired.

### BRIEF DESCRIPTION OF THE DRAWINGS

FIG. 1 is a block diagram illustrating an example software architecture for an application level audio endpoint connection and streaming, in accordance with an example embodiment of the disclosure.

FIG. 2 is a block diagram illustrating the example software architecture of FIG. 1 for an application level audio endpoint connection and streaming to a remote playback device which is not the default audio endpoint, in accordance with an example embodiment of the disclosure.

FIG. 3 is a block diagram illustrating the example software architecture of FIG. 1 for an application level audio endpoint connection and streaming to a remote playback device which is the default audio endpoint, in accordance with an example embodiment of the disclosure.

FIG. 4 is a block diagram illustrating the example software architecture of FIG. 1 for multiple application level audio endpoint connections and streaming to a remote playback device which is not the default audio endpoint, in accordance with an example embodiment of the disclosure.

FIGS. 5-7 are flow diagrams illustrating processing of audio information including application level audio endpoint connection and streaming, in accordance with one or more embodiments.

FIG. 8 is a block diagram illustrating an example mobile computing device in conjunction with which innovations described herein may be implemented.

FIG. 9 is a diagram of an example computing system, in which some described embodiments can be implemented.

### DETAILED DESCRIPTION

As described herein, various techniques and solutions can be applied for application level audio connection and streaming to a wireless endpoint, such as a Bluetooth audio device or another type of a multimedia device that can be used for wireless streaming and playback of multimedia data. Computing devices can connect to remote playback devices (e.g., a Bluetooth audio endpoint) at the system level (e.g., via the operating system audio stack), and send sounds (e.g., system sounds such as keystroke sounds and notification alerts) and streaming audio data to that endpoint. Techniques described herein can be used to enable an application to connect to the remote playback device directly and use the device exclusively for streaming multimedia content associated with the application, without having any other sounds playing back on the selected playback device. Remaining system sounds (e.g., keystroke sounds, notification alerts, and so forth) may be separated from the multimedia content of the application and may be redirected for streaming to another endpoint.

As used herein, the terms “remote playback device,” “multimedia endpoint device,” or “endpoint” are used interchangeably. As used herein, the term “render” (or “rendering”) may be used in the context of video information (e.g., rendering video data on a display monitor), or in the context of audio information (e.g., rendering audio data may include decoding (or other post-processing) and/or playing back of audio information on a remote playback device.

As used herein, the term “streaming” is used in connection with multimedia content (e.g., audio and/or video content), which is constantly received by and presented to an end user via a multimedia endpoint device, while being delivered by a multimedia provider.

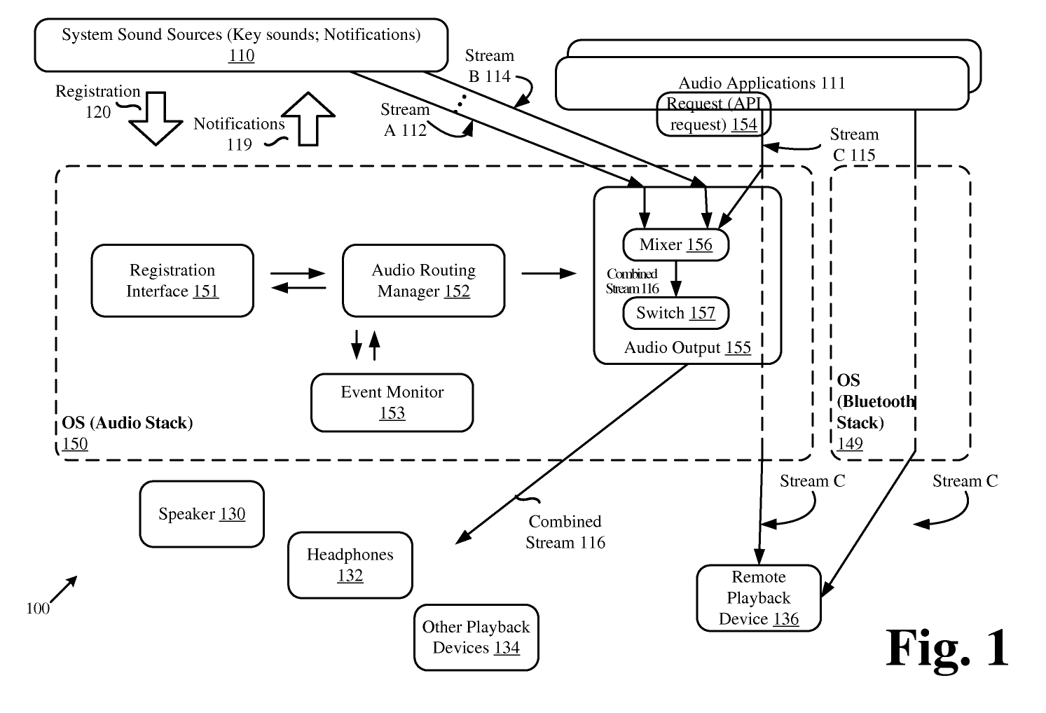

FIG. 1 is a block diagram illustrating an example software architecture (100) for an application level audio endpoint connection and streaming, in accordance with an example embodiment of the disclosure. A computer system (e.g., desktop computer, laptop computer, netbook, tablet computer, smartphone, or another computing device) can execute software organized according to the architecture (100) to manage application level audio connection and streaming for one or more audio applications.

The architecture (100) includes an operating system (150), which can be an operating system audio stack, and one or more audio applications (111). An audio application (111) can be audio streaming application (e.g., a media player), which may be used to access one or more audio streams (e.g., as associated with a multimedia/streaming account of a user), select a remote playback device (RPB), and stream audio information accessed via the application to the selected RPB. The application (111) may also include a voice communication application such as a standalone voice telephony application (VoIP or otherwise), a voice telephony tool in a communication suite, or a voice chat feature integrated into a social network site or multi-player game. Or, an audio application (111) can be an audio recording application, a speech-to-text application, or other audio processing software that can get an audio capture feed. Overall, an audio application (111) can register with the audio routing manager (152) of the operating system (150), and then receive notifications (119) from the audio routing manager (152) about management of the audio capture feed and/or audio output for the application (111). Based on the notifications, the audio application (111) can control the user experience in a way that is consistent with the notifications but left to the application (111). For example, if a voice communication application receives notifications that its audio capture feed and audio output are muted, the application can decide whether to put a call on hold or terminate the call. As another example, a media player application (111) that is streaming to a Bluetooth RPD may receive a notification that the Bluetooth RPD is unavailable (e.g., out of range or powered-off), the application may then send a request to the audio routing manager (152) to disconnect the application stream from the Bluetooth RPD (e.g., 136) and re-route the stream to another RPD that can be used in solo by the application (111).

The operating system (150) includes components for rendering (e.g., rendering visual output to a display and/or generating audio output for a speaker or another RPD), components for networking, components for processing audio capture from a microphone, and components for managing applications. More generally, the operating system (150) manages user input functions, output functions, storage access functions, network communication functions, and other functions for the computer system. The operating system (150) can implement a system audio stack, which may be used to provide access to the above functions to an audio application (111). The operating system (150) can be a general-purpose operating system for consumer or professional use, or it can be a special-purpose operating system adapted for a particular form factor of computer system. In FIG. 1, the audio output (155) represents audio output processing. The audio output (155) conveys audio data to/from the audio application(s) (111) through one or more data paths, as controlled by the audio routing manager (152) through one or more control paths.

In accordance with an example embodiment of the disclosure, the audio routing manager (152) and the audio output (155) may be implemented as a single block (or module). Additionally, even though one or more of the figures (e.g., FIG. 1) represents audio streams being communicated to the audio output block (155), such representation is for simplicity and other arrangements may also be used. For example, data streams (e.g., audio and/or video streams) from the system sound sources (110) and/or the application (111) may be initially communicated to the audio routing manager (152) and then to the audio output module (155) for additional routing to one or more endpoints (e.g., 130, . . . , 136).

The registration interface (151) provides a way for a voice communication application or other type of audio application (111) to register (e.g., using a registration request 120) for notifications from the audio routing manager (152). For example, through the registration interface (151), a voice communication application declares that it uses an audio stream for input and output. Or, a media player application (111) declares that it uses an audio stream (e.g., stream 115) for audio output. The voice communication application or other audio application (111) can also provide other types of information, e.g., category of audio stream. Different stream categories can be associated with different behaviors. For example, a foreground only media stream may be used for a game or film that is paused when it goes to the background. Or, a background capable media stream may be used for music playback that is expected to continue even if a media player or other software associated with the stream is in the background of the UI. A communication stream may be used for voice telephony or real-time chat for a voice communication application. Multiple categories can be assigned to a single application. For audio capture, the category of communication stream indicates a stream that is used for voice telephony, real-time chat, or other voice communication. Alternatively, the architecture (100) accounts for other and/or additional categories for audio streams, such as streams (112, . . . , 114) from system sound sources (110). The system sound sources (110) may be one or more system components of a computing device running the operating system (150), which components may be generating system sounds such as keystroke sounds, notification alerts, and so forth, represented by audio streams (112, . . . , 114).

Through the registration interface (151), an audio application (111) registers to receive various types of notifications (119) from the audio routing manager (152). For example, an audio application (111) can register to receive notifications about the availability and operating status of one or more of the endpoints 130, . . . , 136. A voice communication application or other audio application (111) can also register to receive notifications about its audio playback state, such as whether the application is to be heard at its full volume level, an attenuated (or “ducked”) level, or muted altogether. Alternatively, the architecture (100) accounts for other and/or additional types of notifications (119) for management of audio and application level audio connection and streaming. Typically, notifications are provided to a registered application in response to a trigger event that causes a change in audio capture state and/or audio playback state for one or more of the audio applications (111). An application (111) may also query the audio routing manager (152) for information about its audio capture state or audio playback state.

A user can generate user input that affects audio stream processing and management for voice communication applications and other audio applications (111). The user input can be tactile input such as touchscreen input, mouse input, button presses, key presses or voice input. For example, a user can start an audio application (111) and may from within the application, request a list of available endpoint devices (e.g., 130, . . . , 136). The user may then select from within the application, one of the endpoints (e.g., RPD 136), and may indicate (e.g., via a request, such as 154) that application soloing (or specific use by the application 111) of RPB 136 is desired. The user may also indicate (or select) an audio stream (e.g., an audio stream 115 accessible via the application 111) for playback at the selected RPD 136. The audio stream (115) may then be communicated to the RPD (136), while system sounds associated with the system sound sources (110) (e.g., streams 112, . . . , 114) may be communicated for playback away from the selected RPD 136 (e.g., to one of the other available endpoints 130, . . . , 134).

In other instances, a user may initiate or answer a new call in a voice communication application, or terminate a call. Or, the user may move an audio application (111) from the foreground of the UI to the background, or vice versa, or otherwise change the visibility of the application (111). Or, the user may change which application currently has the focus in the UI. Changes in the status of an audio application (111), resources used by the application (111) or the status of the system are represented with events.

The event monitor (153) monitors the computer system for types of trigger events, listening for certain types of events that will trigger a response by the audio routing manager (152). The trigger events can be application-level messages about the status of an application or resources used by the application, system-level messages about which user is signed in, or other messages. Which types of events qualify as trigger events depends on implementation. In example implementations, the event monitor (153) monitors whether any requests (e.g., application programming interface or API requests) are received from the audio application (111), where the request is associated with application level audio connection and streaming to a specific audio endpoint. The event monitor (153) may monitor availability and operating status of one or more of the endpoints (130, . . . , 136), and provide a notification upon the occurrence of a trigger event (e.g., endpoint is available or unavailable).

The audio routing manager (152) reacts to trigger events from the event monitor (153) by managing audio playback (and audio capture) for audio applications (111). For audio playback, the manager (152) controls which audio streams can be heard/not heard for the audio application(s) (111). The manager (152) may also receive one or more requests from the audio application (111), where the requests may be associated with designating a RPD 136 for soloing (or application specific use) in connection with rendering an audio stream associated with application (111). In this regard, the request may select an audio stream as well as an endpoint for application specific use in connection with playing back the selected stream. In instances when the selected endpoint is a Bluetooth RPD, then the request may be used (e.g., by the manager 152) to initiate in-application Bluetooth pairing and connection with the Bluetooth RPD. The manager (152) may separate the designated stream (e.g., 115) from the remaining incoming streams (e.g., 112, . . . , 114), and may use the audio output (155) to stream the audio application stream 115 to the selected RPD, while routing all other streams (112, . . . , 114) to another RPD.

Alternatively, the operating system (150) includes more or fewer modules. A given module can be split into multiple modules, or different modules can be combined into a single module. For example, the audio routing manager (152) can be split into multiple modules that control different aspects of audio management, or the audio routing manager (152) can be combined with another module (e.g., the audio output (155) or registration interface (151)). Functionality described with reference to one module can in some cases be implemented as part of another module. Or, instead of being part of an operating system, the audio manager can be a standalone application, plugin or other type of software.

In operation, a user may start an audio application 111 (e.g., a media player or subscription-based audio streaming application). The user may provide a selection of an audio stream 115 and an endpoint (e.g., the RPD 136) for an application-specific use (or soloing) in connection with streaming and playing back the audio stream 115. The application 111 may generate a request (e.g., an API request) 154, which may be used to communicate the stream (e.g., 115) and endpoint (e.g., 136) selection to the manager 152. After receiving the request 154, the audio routing manager 152 may initiate a connection between the application 111 and the RPD 136. For example, in instances when the RPD is a Bluetooth device, the manager 152 may initiate pairing and connection of the application 111 (and the computing device running the application) to the Bluetooth RPD 136, thereby providing in-application Bluetooth pairing and connection to a Bluetooth audio endpoint.

Prior to generating the request 154 for application-specific use of the RPD 136, the incoming audio streams (e.g., 112, . . . , 115) are communicated to the audio output 155, where the mixer 156 combines them into a combined stream 116. The switch 157 can be used to direct the combined output to a selected audio endpoint (e.g., a default endpoint selected from the endpoints 130, . . . , 136). Alternatively, streams 112, . . . , 115 may not be combined but may be communicated separately to the selected (e.g., default) audio endpoint.

After the request 154 is received and the in-application pairing and connection to a Bluetooth RPD (e.g., 136) has been completed, the audio routing manager 152 may separate the audio stream 115 associated with application 111 from the remaining streams 112, . . . , 114 associated with the system sound sources 110. The separated audio stream 115 (e.g., as reflected by a dashed line in FIG. 1) may be routed to the RPD 136, while the remaining incoming streams (112, . . . , 114) are routed away from the RPD 136 (e.g., may be routed to one of the remaining audio endpoints 130, . . . , 134). Alternatively, the application stream 115 may be handed off by the operating system 150 audio stack to the Bluetooth stack 149, and the Bluetooth stack 149 may be used for the application level Bluetooth connection and streaming to the Bluetooth RPD (e.g., 136).

In this regard by providing the above functionalities, an application specific use of a Bluetooth (or another wireless type) audio endpoint may be enabled, allowing a user of the computing device and application 111 to pair a Bluetooth audio device (e.g., 136) from the context of an application, without the need to break current workflow and use a system-provided functionality (e.g., system-provided Bluetooth pairing user interface or menu). Additionally, an audio stream may be provided exclusive use (soloing) of a selected Bluetooth endpoint device, instead of rendering other system-related sounds (e.g., streams 112, . . . , 114).

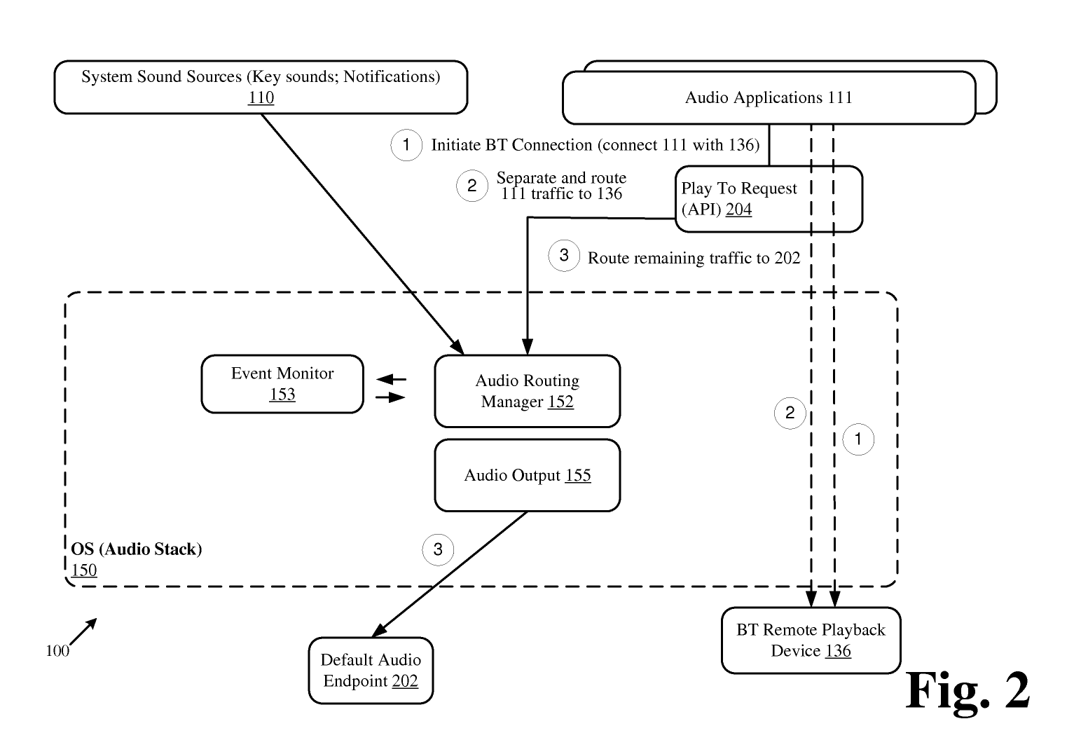

FIG. 2 is a block diagram illustrating the example software architecture of FIG. 1 for an application level audio endpoint connection and streaming to a remote playback device which is not the default audio endpoint, in accordance with an example embodiment of the disclosure. Referring to FIG. 2, the architecture 100 includes a default audio endpoint 202 and a Bluetooth remote playback device 136. The audio application 111 may generate and issue an API request (such as PlayTo request 204). For example, a user may start the application 111 (e.g., a media player application) and a user interface may be presented from within the application displaying a list of available audio endpoints, including the Bluetooth RPD 136. The user may then select the Bluetooth RPD 136 as an audio endpoint for soloing (or application specific use in connection with rendering/playing back an audio stream associated with the application). In addition to the selection of the Bluetooth RPD 136, the request 204 may also (e.g., optionally) provide information and identify a selected audio stream for playing back at the RPD 136.

The request 204 may be detected by the event monitor 153, which may notify the audio routing manager 152 of the incoming request 204. At the time the request 204 is received, the Bluetooth RPD 136 is disconnected and all audio traffic (e.g., from the system sound sources 110 and/or applications 111) is being routed for playback at the default audio endpoint 202. After the request 204 is received by the manager 152, Bluetooth connection and pairing of the RPD 136 and the computing device (running OS 150) and/or the application 111 may be initiated ((1) in FIG. 2). The manager 152 may then separate the selected audio stream of application 111 from the remaining system audio traffic (e.g., from the sources 110), and may route (e.g., using the audio output 155) the separated application audio stream to the Bluetooth RPD 136 ((2) in FIG. 2). The remaining system audio traffic and/or audio traffic from other applications or sound sources may all be routed to the default endpoint 202 for playback ((3) in FIG. 2).

In instances when the application 111 is also associated with a video stream, the application may be notified (e.g., via notification 119) that the selected RPD 136 is audio only, and any video stream may appear on a primary display of the computing device of architecture 100, while the corresponding audio stream is played back on RPD 136. Upon disconnecting the RPD 136, the application 111 may be notified of such disconnection, and any additional application audio stream may be routed to the default endpoint 202.

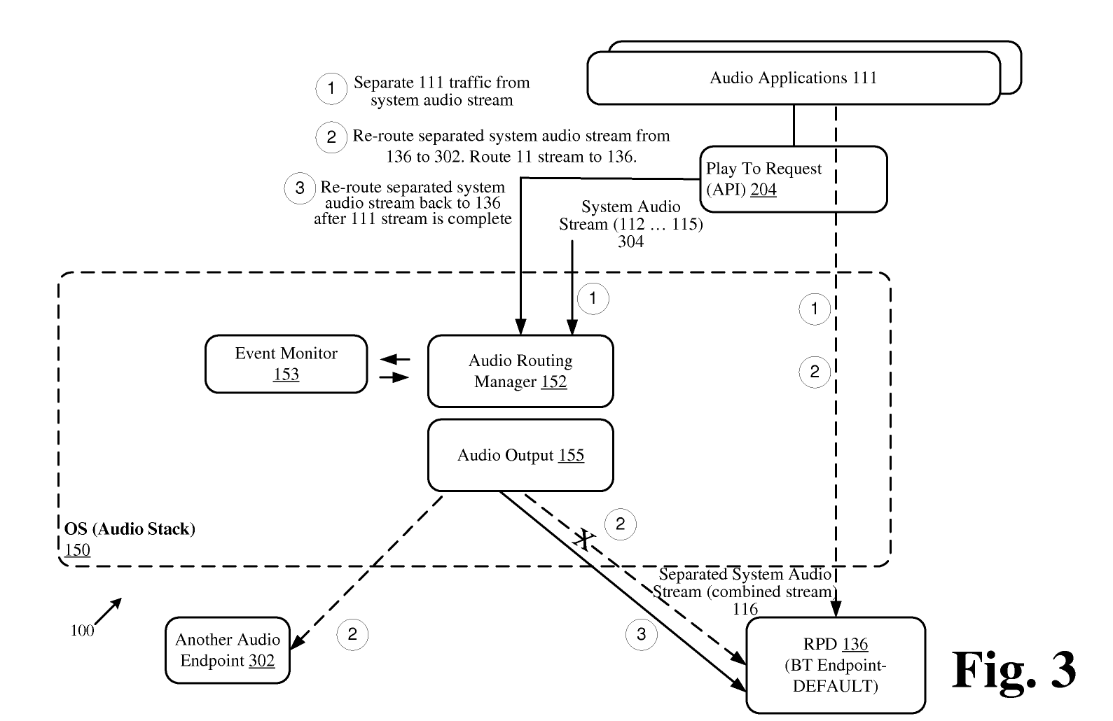

FIG. 3 is a block diagram illustrating the example software architecture of FIG. 1 for an application level audio endpoint connection and streaming to a remote playback device which is the default audio endpoint, in accordance with an example embodiment of the disclosure. Referring to FIG. 3, the architecture 100 includes a default Bluetooth RPD 136 and another audio endpoint 302. The audio application 111 may generate and issue an API request, such as PlayTo request 204. For example, a user may start the application 111 (e.g., a media player application) and a user interface may be presented from within the application displaying a list of available audio endpoints, including the Bluetooth RPD 136. The user may then select the Bluetooth RPD 136 as an audio endpoint for soloing (or application specific use in connection with rendering/playing back an audio stream associated with the application). In addition to the selection of the Bluetooth RPD 136, the request 204 may also (e.g., optionally) provide information and identify a selected audio stream for playing back at the RPD 136.

The request 204 may be detected by the event monitor 153, which may notify the audio routing manager 152 of the incoming request 204. At the time the request 204 is received, the Bluetooth RPD 136 is connected as a default endpoint, and all audio traffic (e.g., from the system sound sources 110 and/or applications 111) is being routed for playback at the default Bluetooth RPD 136. After the request 204 is received by the manager 152, RPD 136 remains as the default endpoint and the audio stream of application 111 may be separated from the remaining system audio traffic (e.g., from the sources 110) ((1) in FIG. 3). The manager 152 may then route (e.g., using the audio output 155) the separated application audio stream to the Bluetooth RPD 136, and the remaining system audio traffic and/or audio traffic from other applications or sound sources may all be routed to another audio endpoint 302 ((2) in FIG. 3).

In instances when the application 111 is also associated with a video stream, the application may be notified (e.g., via notification 119) that the selected RPD 136 is audio only, and any video stream may appear on a primary display of the computing device of architecture 100, while the corresponding audio stream is played back on RPD 136. Additionally, upon disconnecting the audio stream of application 111, the separated application audio stream may be re-routed from the audio endpoint 302 back to the default RPD 136 ((3) in FIG. 3).

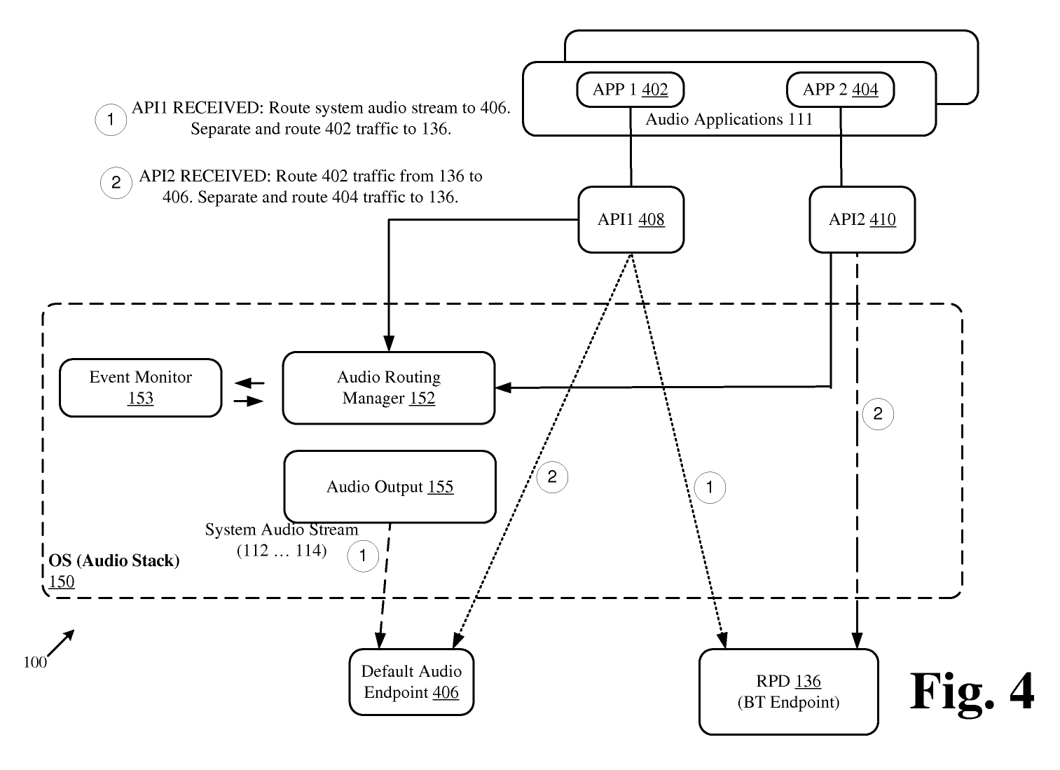

FIG. 4 is a block diagram illustrating the example software architecture of FIG. 1 for multiple application level audio endpoint connections and streaming to a remote playback device which is not the default audio endpoint, in accordance with an example embodiment of the disclosure. Referring to FIG. 4, the architecture 100 includes a default audio endpoint 406 and a Bluetooth RPD 136. A first audio application 402 may generate and issue an API request, such as a first PlayTo request 408. For example, a user may start the application 402 (e.g., a media player application) and a user interface may be presented from within the application displaying a list of available audio endpoints, including the Bluetooth RPD 136. The user may then select the Bluetooth RPD 136 as an audio endpoint for soloing (or application specific use in connection with rendering/playing back an audio stream associated with the application). In addition to the selection of the Bluetooth RPD 136, the request 408 may also (e.g., optionally) provide information and identify a selected audio stream for playing back at the RPD 136.

The request 408 may be detected by the event monitor 153, which may notify the audio routing manager 152 of the incoming request 408. At the time the request 408 is received, the audio endpoint 406 is connected as a default endpoint, and all audio traffic (e.g., from the system sound sources 110 and/or applications 111) is being routed for playback at the default endpoint 406. After the request 408 is received by the manager 152, Bluetooth connection and pairing of the RPD 136 and the computing device (running OS 150) and/or the application 402 may be initiated (if the Bluetooth RPD 136 is not connected). The manager 152 may then separate the selected audio stream of application 408 from the remaining system audio traffic (e.g., from the sources 110), and may route (e.g., using the audio output 155) the separated application audio stream to the Bluetooth RPD 136 ((1) in FIG. 4). The remaining system audio traffic and/or audio traffic from other applications or sound sources may all be routed to the default endpoint 406 for playback ((1) in FIG. 4).

At a subsequent time, a second audio application 404 may issue a second PlayTo request 410, which may be an API request generated by the second application 404. For example, a user may start the application 404 (e.g., a media player application) while application 402 is running, and a user interface may be presented from within the application displaying a list of available audio endpoints, including the Bluetooth RPD 136. The user may then select the Bluetooth RPD 136 as an audio endpoint for soloing (or application specific use in connection with rendering/playing back an audio stream associated with the application 404). In addition to the selection of the Bluetooth RPD 136, the request 410 may also (e.g., optionally) provide information and identify a selected audio stream for playing back at the RPD 136.

The request 410 may be detected by the event monitor 153, which may notify the audio routing manager 152 of the incoming request 410. After the request 408 is received by the manager 152, the audio stream of application 402 is routed to the default audio endpoint 406, and the audio stream of application 404 is routed to the RPD 136 (soloing is now associated with only audio stream of application 404).

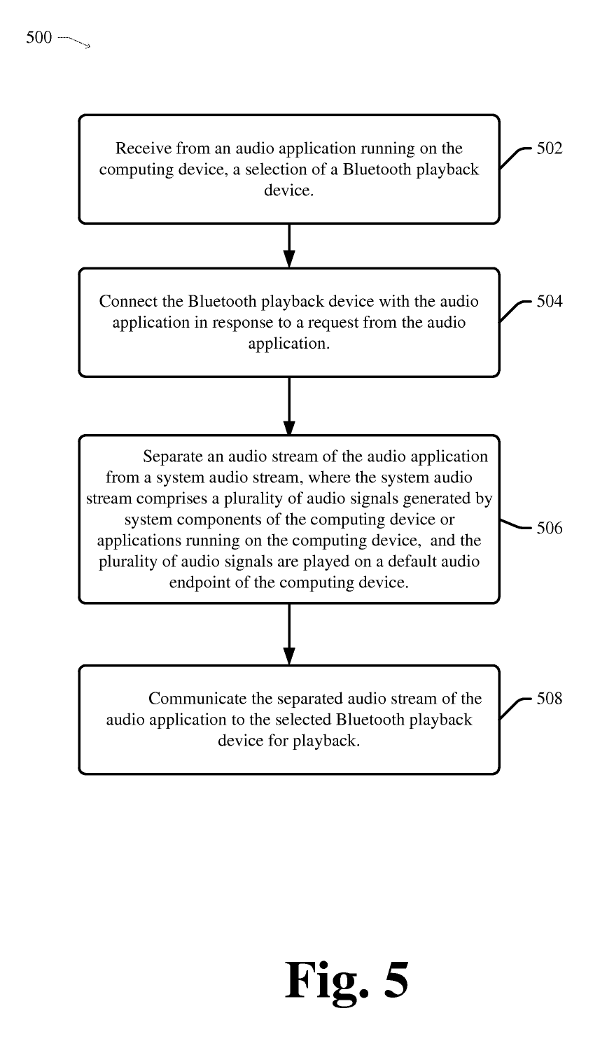

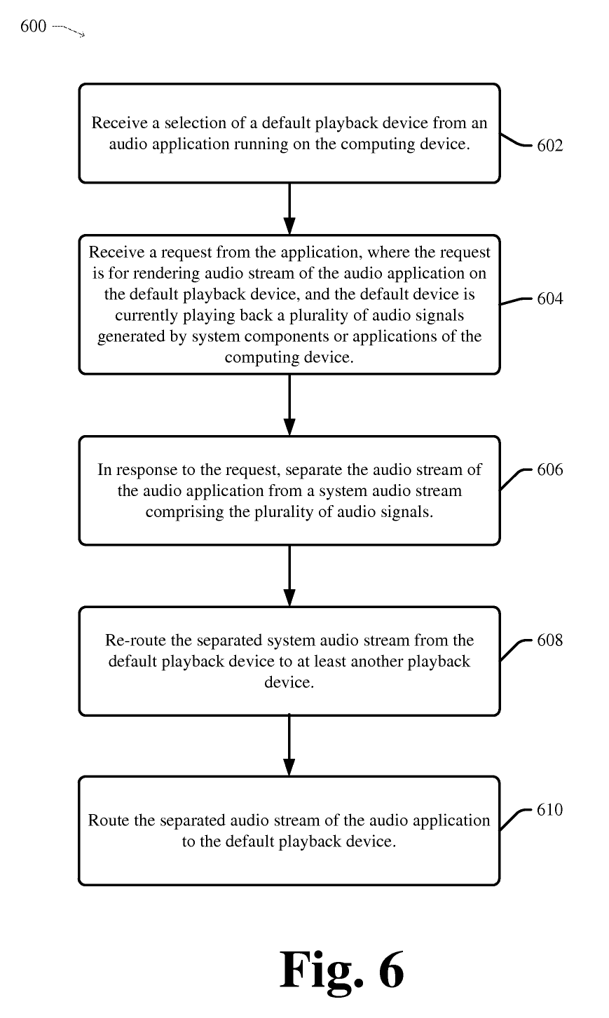

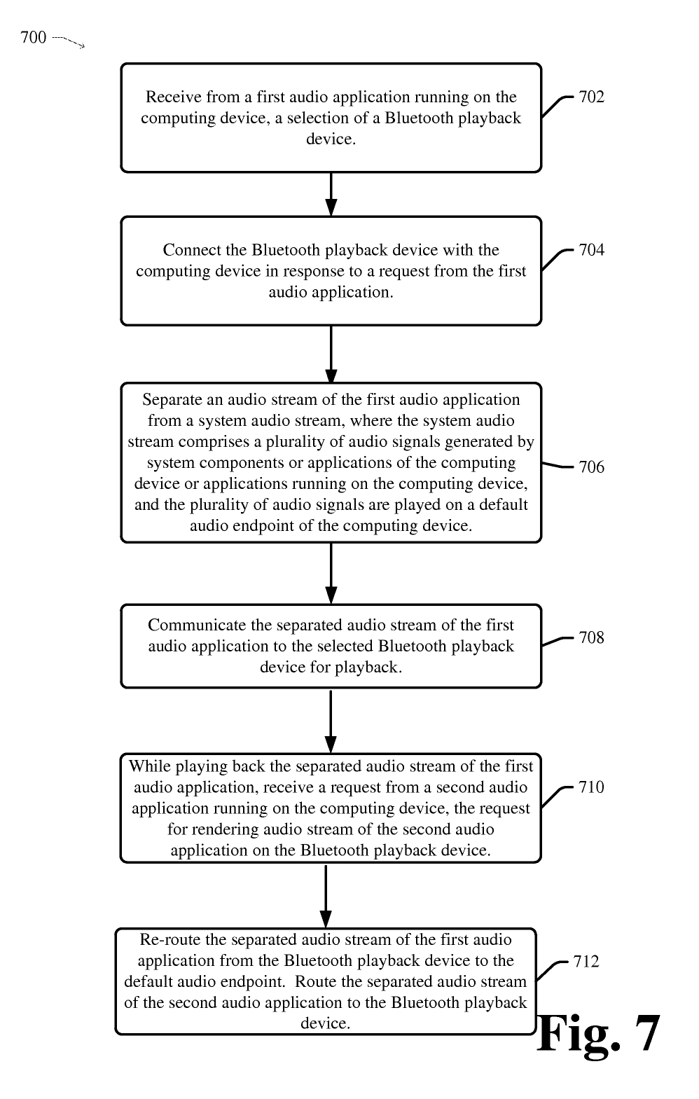

FIGS. 5-7 are flow diagrams illustrating processing of audio information including application level audio endpoint connection and streaming, in accordance with one or more embodiments. Referring to FIGS. 1-5, the example method 500 may start at 502, when a selection of a Bluetooth playback device (136) may be received from an audio application (111) running on a computing device. At 504, in response to a request (204) from the audio application (111), the Bluetooth playback device (136) may be connected with the audio application (e.g., process (1) in FIG. 2). At 506, an audio stream (115) of the audio application (111) may be separated from a system audio stream (e.g., 112, . . . , 114). The system audio stream may include a plurality of audio signals (e.g., streams 112, . . . , 114) generated by system components (e.g., sources 110) of the computing device or applications running on the computing device. The plurality of audio signals of the system audio stream may be played on a default audio endpoint (202) of the computing device. At 508, the separated audio stream (115) of the audio application (111) may be communicated to the selected Bluetooth playback device (136) for playback.

Referring to FIGS. 1, 3, and 6, the example method 600 may start at 602, when a selection of a default playback device (136 in FIG. 3) may be received from an audio application (111) running on the computing device. At 604, a request (e.g., 204) may be received (e.g., by manager 152) from the audio application (111). The request (204) is for rendering audio stream (115) of the audio application on the default playback device (136 is the default endpoint in FIG. 3). The default playback device (136) may be currently playing back a plurality of audio signals generated by system components of the computing device or applications running on the computing device (e.g., streams 112, . . . , 114 from system sound sources 110 and/or streams from other application). At 606, in response to the request, the audio routing manager 152 may separate the audio stream (115) of the audio application from a system audio stream (e.g., 112, . . . , 114) comprising the plurality of audio signals. At 608, the separated system audio stream (e.g., 112, . . . , 114) may be re-routed from the default playback device (136) to at least another playback device (e.g., 302). At 610, the manager 152 may route the separated audio stream (115) of the audio application to the default playback device (136) for playback.

Referring to FIGS. 1, 4 and 7, the example method 700 may start at 702, when a selection of a Bluetooth playback device (136 in FIG. 4) may be received from a first audio application (402) running on a computing device. At 704, the Bluetooth playback device (136) may be paired and connected with the computing device in response to a request (e.g., 408) from the first audio application (402). At 706, the audio manager 152 may separate an audio stream of the first audio application (402) from a system audio stream. The system audio stream may include a plurality of audio signals generated by system components of the computing device (e.g., streams 112, . . . , 114 from 110) or applications running on the computing device. The plurality of audio signals of the system audio stream may be played on a default audio endpoint (e.g., 406) of the computing device. At 708, the audio manager 152 and the audio output 155 may communicate the separated audio stream of the first audio application (402) to the selected Bluetooth playback device (136) for playback. At 710, while playing back the separated audio stream of the first audio application, the manager 152 may receive a request (e.g., 410) from a second audio application (e.g., 404) running on the computing device. The request (410) may be for rendering audio stream of the second audio application (404) on the same Bluetooth playback device (136). At 712, the audio routing manager 152 may re-route the separated audio stream of the first audio application (402) from the Bluetooth playback device (136) to the default audio endpoint (406), and may route the separated audio stream of the second audio application (404) to the Bluetooth playback device.

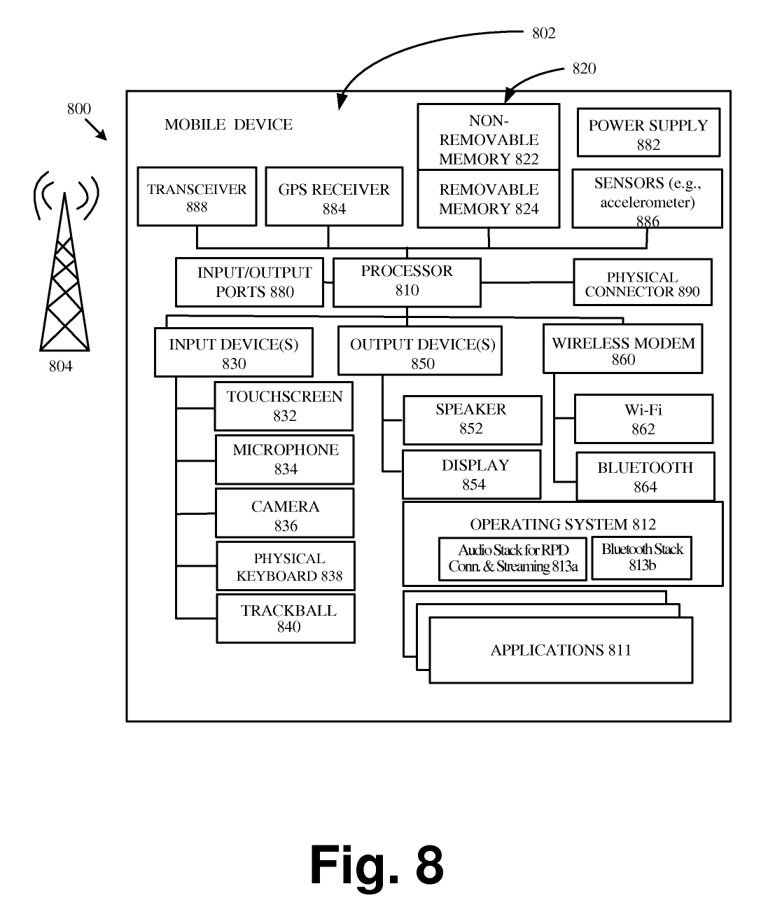

FIG. 8 is a block diagram illustrating an example mobile computing device in conjunction with which innovations described herein may be implemented. The mobile device 800 includes a variety of optional hardware and software components, shown generally at 802. In general, a component 802 in the mobile device can communicate with any other component of the device, although not all connections are shown, for ease of illustration. The mobile device 800 can be any of a variety of computing devices (e.g., cell phone, smartphone, handheld computer, laptop computer, notebook computer, tablet device, netbook, media player, Personal Digital Assistant (PDA), camera, video camera, etc.) and can allow wireless two-way communications with one or more mobile communications networks 804, such as a Wi-Fi, cellular, or satellite network.

The illustrated mobile device 800 includes a controller or processor 810 (e.g., signal processor, microprocessor, ASIC, or other control and processing logic circuitry) for performing such tasks as signal coding, data processing (including assigning weights and ranking data such as search results), input/output processing, power control, and/or other functions. An operating system 812 controls the allocation and usage of the components 802 and support for one or more application programs 811. The operating system 812 may include an audio stack 813a for application level audio connection and streaming as well as other wireless connection and streaming as described herein. The audio stack 813a may have functionalities that are similar to the operating system audio stack 150 in FIGS. 1-4. The operating system 812 may also include a Bluetooth stack 813b, which may be similar in functionalities to the Bluetooth stack 149.

The illustrated mobile device 800 includes memory 820. Memory 820 can include non-removable memory 822 and/or removable memory 824. The non-removable memory 822 can include RAM, ROM, flash memory, a hard disk, or other well-known memory storage technologies. The removable memory 824 can include flash memory or a Subscriber Identity Module (SIM) card, which is well known in Global System for Mobile Communications (GSM) communication systems, or other well-known memory storage technologies, such as “smart cards.” The memory 820 can be used for storing data and/or code for running the operating system 812 and the applications 811. Example data can include web pages, text, images, sound files, video data, or other data sets to be sent to and/or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 800 can support one or more input devices 830, such as a touch screen 832 (e.g., capable of capturing finger tap inputs, finger gesture inputs, or keystroke inputs for a virtual keyboard or keypad), microphone 834 (e.g., capable of capturing voice input), camera 836 (e.g., capable of capturing still pictures and/or video images), physical keyboard 838, buttons and/or trackball 840 and one or more output devices 850, such as a speaker 852 and a display 854. Other possible output devices (not shown) can include piezoelectric or other haptic output devices. Some devices can serve more than one input/output function. For example, touchscreen 832 and display 854 can be combined in a single input/output device. The mobile device 800 can provide one or more natural user interfaces (NUIs). For example, the operating system 812 or applications 811 can comprise multimedia processing software, such as audio/video player.

A wireless modem 860 can be coupled to one or more antennas (not shown) and can support two-way communications between the processor 810 and external devices, as is well understood in the art. The modem 860 is shown generically and can include, for example, a cellular modem for communicating at long range with the mobile communication network 804, a Bluetooth-compatible modem 864, or a Wi-Fi-compatible modem 862 for communicating at short range with an external Bluetooth-equipped device or a local wireless data network or router. The wireless modem 860 is typically configured for communication with one or more cellular networks, such as a GSM network for data and voice communications within a single cellular network, between cellular networks, or between the mobile device and a public switched telephone network (PSTN).

The mobile device can further include at least one input/output port 880, a power supply 882, a satellite navigation system receiver 884, such as a Global Positioning System (GPS) receiver, sensors 886 such as an accelerometer, a gyroscope, or an infrared proximity sensor for detecting the orientation and motion of device 800, and for receiving gesture commands as input, a transceiver 888 (for wirelessly transmitting analog or digital signals), and/or a physical connector 890, which can be a USB port, IEEE 1394 (FireWire) port, and/or RS-232 port. The illustrated components 802 are not required or all-inclusive, as any of the components shown can be deleted and other components can be added.

The mobile device can determine location data that indicates the location of the mobile device based upon information received through the satellite navigation system receiver 884 (e.g., GPS receiver). Alternatively, the mobile device can determine location data that indicates location of the mobile device in another way. For example, the location of the mobile device can be determined by triangulation between cell towers of a cellular network. Or, the location of the mobile device can be determined based upon the known locations of Wi-Fi routers in the vicinity of the mobile device. The location data can be updated every second or on some other basis, depending on implementation and/or user settings. Regardless of the source of location data, the mobile device can provide the location data to map navigation tool for use in map navigation.

As a client computing device, the mobile device 800 can send requests to a server computing device (e.g., a search server, a routing server, and so forth), and receive map images, distances, directions, other map data, search results (e.g., POIs based on a POI search within a designated search area), or other data in return from the server computing device.

The mobile device 800 can be part of an implementation environment in which various types of services (e.g., computing services) are provided by a computing “cloud.” For example, the cloud can comprise a collection of computing devices, which may be located centrally or distributed, that provide cloud-based services to various types of users and devices connected via a network such as the Internet. Some tasks (e.g., processing user input and presenting a user interface) can be performed on local computing devices (e.g., connected devices) while other tasks (e.g., storage of data to be used in subsequent processing, weighting of data and ranking of data) can be performed in the cloud.

Although FIG. 8 illustrates a mobile device 800, more generally, the innovations described herein can be implemented with devices having other screen capabilities and device form factors, such as a desktop computer, a television screen, or device connected to a television (e.g., a set-top box or gaming console). Services can be provided by the cloud through service providers or through other providers of online services. Additionally, since the technologies described herein may relate to audio streaming, a device screen may not be required or used (a display may be used in instances when audio/video content is being streamed to a multimedia endpoint device with video playback capabilities).

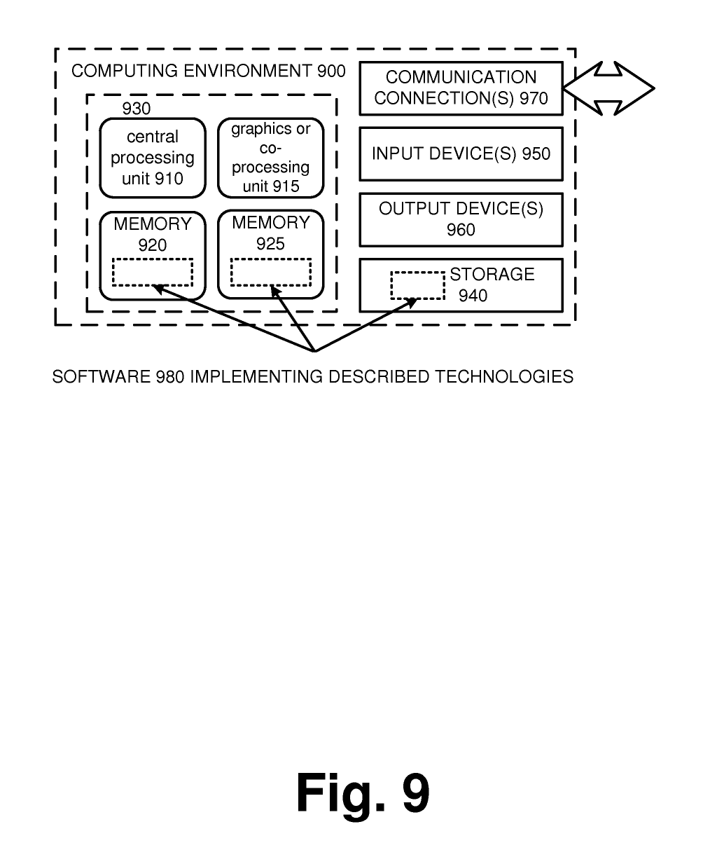

FIG. 9 is a diagram of an example computing system, in which some described embodiments can be implemented. The computing system 900 is not intended to suggest any limitation as to scope of use or functionality, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s).

A computing system may also have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. For video encoding, the input device(s) 950 may be a camera, video card, TV tuner card, or similar device that accepts video input in analog or digital form, or a CD-ROM or CD-RW that reads video samples into the computing system 900. The output device(s) 960 may be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 9, computer-readable storage media include memory 920 and 925, and storage 940. The term “computer-readable storage media” does not include signals and carrier waves. In addition, the term “computer-readable storage media” does not include communication connections (e.g., 970).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Pert, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. In a computing device, a method for processing audio information, the method comprising:
receiving from an audio application running on the computing device, a selection of a multimedia endpoint device;
connecting the multimedia endpoint device with the audio application in response to a request from the audio application;
separating an audio stream of the audio application from a system audio stream, wherein:
the audio stream of the audio application is exclusively associated with the audio application;
the system audio stream comprises a plurality of audio signals generated by system components of the computing device or applications running on the computing device; and
the plurality of audio signals are played on a default audio endpoint of the computing device; and
communicating the separated audio stream of the audio application to the selected multimedia endpoint device for playback.

2. The method according to claim 1, comprising:
receiving the request from the audio application; and
separating the audio stream of the audio application from the system audio stream based on the request.

3. The method according to claim 1, wherein:
the multimedia endpoint is a Bluetooth audio and/or video-enabled endpoint device; and
the request is an application programming interface (API) request.

4. The method according to claim 1, wherein the plurality of audio signals comprise at least one of keystroke sounds and notification alert sounds.

5. The method according to claim 1, comprising:
receiving a selection of the audio stream from a plurality of audio streams associated with a user account for the audio application.

6. The method according to claim 1, comprising:
playing at least one of the plurality of audio signals on the default audio endpoint, while streaming the separated audio stream to the multimedia endpoint device.

7. The method according to claim 1, comprising:
detecting the multimedia endpoint device is unavailable for playback.

8. The method according to claim 7, comprising:
upon detecting the multimedia endpoint device is unavailable, re-routing the audio stream from the Bluetooth playback device to the default audio endpoint for playback.

9. The method according to claim 1, comprising:
communicating the separated audio stream of the audio application to the selected multimedia endpoint device using a system audio stack of the computing device.

10. A computing device that includes a processor and memory, the computing device being adapted to perform a method for processing audio information, the method comprising:
receiving a selection of a default playback device from an audio application running on the computing device;
receiving a request from the audio application, wherein:
the request is for rendering audio stream of the audio application on the default playback device; and
the default playback device plays back a plurality of audio signals generated by system components of the computing device or applications running on the computing device;
in response to the request, separating the audio stream of the audio application from a system audio stream comprising the plurality of audio signals;
re-routing the separated system audio stream from the default playback device to at least another playback device; and
routing the separated audio stream of the audio application to the default playback device for playback.

11. The computing device according to claim 10, wherein the method further comprises:
using the audio application, receiving a selection of the audio stream from a plurality of audio streams associated with a user account for the audio application.

12. The computing device according to claim 10, wherein the request is an API request and the method further comprises:
receiving the selection of the default playback device using the API request.

13. The computing device according to claim 10, wherein the method further comprises:
detecting completion of the audio stream of the audio application.

14. The computing device according to claim 13, wherein the method further comprises:
upon detecting the completion of the audio stream, re-routing the system audio stream to the default playback device for rendering.

15. The computing device according to claim 10, wherein the default playback device is a Bluetooth playback device and the method further comprises:
communicating the separated audio stream to the Bluetooth playback device using a Bluetooth stack of the computing device.

16. The computing device according to claim 15, wherein the method further comprises:
communicating the separated audio stream to the Bluetooth playback device, while playing back at least one of the plurality of audio signals of the separated system audio stream at the at least another playback device.

17. A computer-readable storage medium including instructions that upon execution cause a computer system to:
receive from a first audio application running on the computing device, a selection of a Bluetooth playback device;
connect the Bluetooth playback device with the computing device in response to a request from the first audio application;
separate an audio stream of the first audio application from a system audio stream, wherein:
the system audio stream comprises a plurality of audio signals generated by system components of the computing device or applications running on the computing device; and
the plurality of audio signals are played on a default audio endpoint of the computing device;
communicate the separated audio stream of the first audio application to the selected Bluetooth playback device for playback;
while playing back the separated audio stream of the first audio application, receive a request from a second audio application running on the computing device, the request for rendering audio stream of the second audio application on the Bluetooth playback device; and
re-route the separated audio stream of the first audio application from the Bluetooth playback device to the default audio endpoint.

18. The computer-readable storage medium according to claim 17, wherein the instructions, upon execution further cause the computer system to:
in response to the request from the second audio application, separate the audio stream of the second audio application from the system audio stream.

19. The computer-readable storage medium according to claim 18, wherein the instructions, upon execution further cause the computer system to:
route the separated audio stream of the second audio application to the Bluetooth playback device.

20. The computer-readable storage medium according to claim 18, wherein the instructions, upon execution further cause the computer system to:
upon detecting completion of the audio stream of the second audio application, re-route the separated audio stream of the first audio application from the default audio endpoint to the Bluetooth playback device.
